(19) United States
(12) Patent Application Publication
(10) Pub. No.: US 2014/0268865 A1
(43) Pub. Date: Sep. 18, 2014

(54) SIDE EMITTING OPTICAL APPARATUS AND METHOD FOR POSSIBLE USE IN AN AIRCRAFT

(71) Applicant: IDD Aerospace Corporation, Redmond, WA (US)

(72) Inventor: Mary Ann Matthew, Kirkland, WA (US)

(73) Assignee: IDD Aerospace Corporation, Redmond, WA (US)

(21) Appl. No.: 14/210,676

(22) Filed: Mar. 14, 2014

Related U.S. Application Data
(63) Continuation-in-part of application No. 14/014,563, filed on Aug. 30, 2013.
(60) Provisional application No. 61/786,905, filed on Mar. 15, 2013.

(51) Int. Cl. F21V 8/00; F21S 8/10

(52) U.S. Cl. CPC G02B 6/0006; F21S 48/236
USPC 362/558; 362/470

(57) ABSTRACT

Side emitting optical apparatuses and methods having an optical grade silicone component. Optionally, the optical grade silicone includes a plurality of diffusive side areas that are configured to disrupt the travel path of a light ray traversing along a longitudinal axis of the optical element to re-direct the light ray out of the side of the optical element. The optical apparatus is configured such that the light is emitted more uniformly along a length of the optical apparatus.

### RELATED APPLICATIONS

This application claims the benefit of U.S. Provisional Application No. 61/786,905 filed Mar. 15, 2013 and is a continuation-in-part application of U.S. Ser. No. 14/014,563 filed Aug. 30, 2013, which in turn claims the benefit of U.S. Provisional Application No. 61/695,445 filed Aug. 31, 2012, the contents of all of which are incorporated herein by reference.

### FIELD OF THE INVENTION

This invention relates to side emitting optical apparatuses and methods.

### BACKGROUND

Side emitting fiber optics used for illumination can be ineffective in controlling the light emitted in a desired direction. In general, side emitting fibers produce light circumferentially around the fiber periphery and along the length of the fiber. However, the homogeneity of the light intensity along the length of the fiber is not consistent. As such, side emitting fiber optics are typically only used for accent lighting and decorative lighting systems. Moreover, traditional materials used for side emitting fiber optics such as acrylic are flammable and therefore cannot be used in aircraft and other applications.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Side emitting optical apparatuses that better control the direction of emitted light and that increase the homogeneity of the light intensity across the length of the optical apparatus are disclosed herein. The disclosed side emitting optical apparatuses may include at least one optical grade silicone component that is non-flammable and that helps control the direction of the emitted light.

Disclosed is an optical element configured for use in an aircraft, the optical element comprising: an optical grade silicone component; a distal end and a proximate end adapted to be coupled to a light source; and a plurality of diffusive side areas arranged on the silicone component, wherein each of the diffusive side areas is configured to re-direct a light ray traversing by total internal reflection along a longitudinal axis of the optical element so that the light ray is emitted out of the optical element generally orthogonal to the longitudinal axis; wherein a distance between adjacent diffusive side areas decreases along a length of the optical element from the proximate end toward the distal end.

In some embodiments, the distance between adjacent diffusive side areas linearly decreases along the length of the optical element from the proximate end toward the distal end.

In some embodiments, the decrease in the distance between adjacent diffusive side areas increases the uniformity of the light rays being emitted out of the optical element.

In some embodiments, the silicone component is positioned within an aperture of a transparent, rigid rod.

In some embodiments, the silicone component at least partially surrounds a rigid rod.

In some embodiments, the optical element further comprises a reflective element on the distal end of the optical element.

In some embodiments, the diffusive side areas are arranged as strips.

In some embodiments, the diffusive side areas are generally prism shaped.

In some embodiments, the diffusive side areas are generally wedge shaped.

The optical element of claim 1, wherein the diffusive side areas are texturized areas.

Also disclosed is an optical element adapted to be coupled to a light source, the optical element comprising: an optical grade silicone component; a proximate end and a distal end; and a plurality of diffusive side areas arranged on the optical grade silicone component, wherein each of the diffusive side areas is positioned on the silicone component and is configured to re-direct a light ray traversing along a longitudinal axis of the optical element such that the light ray is emitted out of the optical element generally orthogonal to the longitudinal axis, wherein the diffusive side areas are arranged such that a probability of the light ray hitting one of the plurality of diffusive side areas increases as the light ray moves from the proximate end toward the distal end of the optical element.

In some embodiments, a distance between adjacent diffusive side areas decreases along the length of the optical element from the proximate end toward the distal end.

In some embodiments, the distance between adjacent diffusive side areas linearly decreases along the length of the optical element from the proximate end toward the distal end.

In some embodiments, the arrangement of the diffusive side areas increases the uniformity of the light rays being emitted out of the optical element.

In some embodiments, the optical component further comprises a transparent, rigid rod and wherein the silicone component either surrounds the rod or is positioned within an aperture of the rod.

In some embodiments, the diffusive side areas are arranged as strips.

In some embodiments, the diffusive side areas are generally prism shaped.

In some embodiments, the diffusive side areas are one or more tapered strips, wherein a wider end of the strip is positioned toward the distal end of the optical element.

In some embodiments, the diffusive side areas are generally wedge shaped and wherein a height of the generally wedge shaped diffusive side areas increases along a length of the optical element from the proximate end to the distal end.

In some embodiments, the diffusive side areas are coated with a reflective material.

In some embodiments, the diffusive side areas are texturized.

Also disclosed is a method of using an optical element in an aircraft, the method comprising: providing an optical element comprising an optical grade silicone component; coupling the optical element to a light source; and directing a light ray into the optical element along a longitudinal axis of the optical element such that the light ray is re-directed and emitted out of the optical element generally orthogonal to the longitudinal axis in a uniform matter along a length of the optical element.

In some embodiments, the method further comprises at least partially surrounding a rigid rod with the optical grade silicone component.

In some embodiments, the method further comprises positioning the optical grade silicone component within an aperture of a rigid rod.

### BRIEF DESCRIPTION OF THE DRAWINGS

Illustrative embodiments of the present invention are described in detail below with reference to the following drawing figures:

FIG. 1 is a side view of an optical apparatus according to one embodiment.

FIG. 2 is a schematic illustrating the path of light rays through a portion of an optical apparatus according to one embodiment.

FIG. 3 is a section view taken along the line A-A of FIG. 2.

FIGS. 4-5 show section views of alternate optical apparatuses.

FIGS. 6-9 show bottom views of optical apparatuses according to various embodiments.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Described herein are apparatuses and methods for distributing light from an optical element to a target surface to illuminate the target surface. As shown in FIGS. 1-5, an apparatus 10 includes an optical element 12, which may be a cylindrical rod, a parallelepiped, or other structure. The optical element 12 is generally transparent and includes optical grade silicone. Some examples of a suitable optical grade silicone include, but are not limited to, Dow Corning® MS-1002 Moldable Silicone, Dow Corning® MS-1003 Moldable Silicone, Dow Corning® OE-6636 Optical Encapsulate, and Dow Corning® OS-6550 Optical Encapsulate.

In some case, the optical element 12 is formed at least partially of optical grade silicone. For instance, optical grade silicone may be molded into a rod or other desired structure that serves as optical element 12. In other cases, optical element 12 is a clear rigid rod 8 (which may be acrylic or any other suitable material having substantially the same refractive index as optical grade silicone and may have any suitable shape and dimensions) that is encapsulated or at least partially surrounded by optical grade silicone 6 as shown in FIG. 4. As one non-limiting example, the silicone and acrylic (or other suitable material) can be molded together in a co-molding or other suitable process. And in yet other cases, the optical element 12 includes optical grade silicone resin 6 that is inserted into an opening of an acrylic or polycarbonate or other rigid rod or tube 8, as shown in FIG. 5. When the silicone is used in conjunction with a polycarbonate or acrylic or other rigid rod, the rod provides structural rigidity to the optical element.

As shown in FIG. 2, the optical element 12 has a proximate end 15 and a distal end 17. Light rays 16 emitted from a light source (such as, but not limited to, an incandescent bulb, an arc lamp, a light emitting diode (LED), etc.) enter proximate end 15 of the optical element 12. As shown in FIG. 1, a light engine 18 may couple the optical element 12 with an LED 13 or other suitable light source. Light rays 16 can be inserted into the optical element 12 from various methods including but not limited to the light engines described above. Light rays 16 traverse along longitudinal axis L of the optical element 12 toward distal end 17 and bounce off the surfaces of optical element 12 by total internal reflection (TIR) or standard specular reflecting off a reflecting coating such as metallization or low index of refraction cladding.

In some cases, the optical grade silicone 6 of optical element 12 has light scattering properties that causes the light rays 16 to scatter and disperse uniformly across the length of the optical element such that the light provides a uniform illumination pattern without additional treatment such as diffusive side areas shown in FIGS. 2 and 6-9 and discussed in more detail below.

In the non-limiting embodiment shown in FIG. 2, diffusive side areas 14 are located periodically along a portion (such as a side) of the optical element 12. For simplicity and with reference to FIG. 2, side surface 26 is referred to as the “top” of the optical element 12 and side surface 28 is referred to as the “bottom” of the optical element 12, although such directional references are not intended to be limiting. As shown in FIG. 2, diffusive side areas 14 may be applied along bottom side surface 28 of the optical element 12, although the location of the diffusive side areas 14 along the optical element 12 may vary depending on the orientation of the optical element relative to the target surface. When a light ray 16 encounters one of the diffusive side areas 14, the light ray reflects in accordance with the surface bi-directional reflectance distribution (BRDF) and is redirected by the diffusive side area 14 to be emitted out of the top side surface 26 of the optical element 12 toward a target surface 30 (FIG. 3).

In this way, the diffusive side areas 14 are configured to cause a disruption in the axial transmission of the light ray 16 along the longitudinal axis L of the optical element 12. In particular, the diffusive side areas 14 are configured to transmit the light ray generally orthogonal to the longitudinal axis L of the optical element 12 so the light ray is emitted out of the optical element 12. FIGS. 2-3 illustrate a re-directed ray 22 that is emitted out of the top side surface 26 of the optical element 12 and out toward a target surface 30. If the optical element 12 is generally cylindrical, the surface of the optical element 12 behaves like a bi-convex lens and magnifies the light ray 22 after it hits the diffusive side area 14 and is emitted out of the optical element 12 as light ray 24 (FIG. 3). Reflected light rays may be Lambertian or Gaussian in nature, although they need not be.

In some embodiments, diffusive side areas 14 are nontransparent, specular/diffused reflective surfaces that are applied in any suitable pattern, as discussed in more detail below. In some embodiments, the diffusive side areas 14 are areas of white or silver paint. In other embodiments, diffusive side areas 14 are texturized areas such as indents, rough areas (which may be formed by sandblasting or otherwise), or any other suitable surface that interrupts the TIR of the light ray and causes it to change direction and be emitted out of the optical element 12 generally orthogonal to the longitudinal axis L of the optical element 12.

The length of the diffusive side areas 14 may be determined from the magnification factor of the optical element 12. In other words, the length of the diffusive side area 14 may be determined from angular extents of the area to be illuminated, taking into consideration the magnification produced by the curvature of the optical element 12. The length of the diffusive side areas 14 also may be determined based on the amount of light desired to be extracted. Optionally, a reflective material such as aluminum tape or other suitable reflective material may be applied to the diffusive side area 14 to enhance the light output in the desired direction.

Diffusive side areas 14 may be applied to the optical grade silicone component of the optical element, whether the optical grade silicone itself is molded into optical element 12, the optical element 12 includes a rigid rod that is encapsulated by the silicone component, or the optical element 12 includes silicone that is inserted into a rigid rod or tube. More specifically, the diffusive side areas 14 are arranged along the silicone component 6 of the optical element 12 such that the re-directed light rays 22 are emitted more uniformly from the optical element 12 along the length of the optical element 12 (along the longitudinal axis L of the optical element 12). In some cases, the diffusive side areas 14 are patterned to control uniformity. As shown in FIGS. 2 and 6-7, the diffusive side areas 14 are spaced closer together toward the distal end 17 of the optical element 12 than they are at the proximate end 15. In this way, the space S between adjacent diffusive side areas 14 decreases along the length of optical element 12 from the proximate end 15 to the distal end 17 of the optical element 12. Such spacing may be referred to as a dither pattern. The decrease in separation between adjacent diffusive side areas 14 may be linear, non-linear, exponential or otherwise so long as the spacing between diffusive side areas 14 at the distal end 17 is smaller than the spacing between diffusive side areas 14 at the proximate end 15. Decreasing the spacing between diffusive side areas 14 in this way increases the probability that a light ray 16 hits the diffusive side area 14 as the light ray moves along the longitudinal axis L toward distal end 17.

The probability that a light ray 16 hits the diffusive side area 14 as the light ray moves along the longitudinal axis L toward distal end 17 similarly may be manipulated by increasing the surface area of the diffusive side areas from the proximate end 15 to the distal end 17 of the optical element 12. For example, at least one of the height and the length of the diffusive side area 14 may be increased to increase the surface area of the diffusive side area 14. Altering the surface area of some of the diffusive side areas is another way of manipulating the spacing between diffusive side areas 14 as discussed above. The increased surface area of the diffusive side areas may be linear, non-linear, exponential or otherwise so long as the surface area of diffusive side areas 14 at the distal end 17 is greater than the surface area of diffusive side areas 14 at the proximate end 15. Increasing the surface area of diffusive side areas 14 in this way increases the probability that a light ray 16 hits the diffusive side area 14 as the light ray moves along the longitudinal axis L toward distal end 17.

The described spacing pattern and/or surface area pattern helps control how much light exits the element at any particular point along the length of the optical element 12 to increase the uniformity of the light output along the length of the optical element 12. In particular, because diffusive side areas 14 are spaced closer together and/or have greater surface area toward distal end 17, it is more likely that a light ray will contact the diffusive side area 14 and be re-directed out of the optical element 12 if such light ray reaches the distal end 17 than it would be if the diffusive side areas 14 were spaced further apart and/or had less surface area at the distal end 17.

In some embodiments, the diffusive side areas 14 are strips as shown in FIG. 6. Height H of the diffusive side areas 14 affects the surface area of the diffusive side areas 14 and therefore can be manipulated as needed to achieve the desired light distribution. For example, although the height H of the diffusive side areas 14 is illustrated in FIG. 4 as substantially traversing the bottom side surface 28, the height H of the diffusive side areas may vary depending on the desired light output. Because the angular cone of light emitted from the optical element increases as the height H increases, the height of the diffusive side area can be used to control the area of light emitted from the optical element 12. The height H of the diffusive side areas may be uniform throughout the optical element 12 as shown in FIG. 6, or may vary depending on the shape of the area to be illuminated. For example, if it is desired that different parts of the target surface be illuminated differently, the height H of the diffusive side areas may vary along the length of the optical element 12. Similarly, the length of the diffusive side areas can be varied as desired to control the intensity of light emitted from the optical element 12 along the length of the optical element 12. The length of the diffusive side areas may be uniform throughout the optical element 12 as shown in FIG. 6, or may vary depending on the shape of the area to be illuminated.

Instead of strips as shown in FIG. 6, the diffusive side areas may prism-shaped/wedged/ridged areas 14 as shown in FIG. 7 or may be lopped wedges/ridges 14 as shown in FIG. 8 or may be any suitable shape or pattern. For example, the diffusive side areas may be applied in any suitable pattern, such as spirals, dot matrices, etc., to produce a desired illumination pattern. FIG. 9 shows an example where the diffusive side area 14 is one or more tapered stripes with the wider end of the taper positioned towards the distal end 17 of the optical element 12.

As with the striped pattern, the spacing between wedged shaped areas 14 may gradually decrease along the length of the element toward distal end 17, and/or the surface area of the wedged shaped areas 14 may increase along the length of the element toward distal end 17. If lopped wedges (or any other suitable shape) are used as shown in FIG. 8, the spacing between diffusive side areas 14 may be uniform along the length of the optical element (as illustrated in FIG. 8), or may decrease along the length of the optical element 12 as discussed above.

In some embodiments, as shown in FIG. 8, a gap G between the diffusive side area 14 and the optical element may gradually decrease along the length of the optical element toward distal end 17. Decreasing the gap G has the same effect as decreasing the spacing between diffusive side areas 14 in that the probability of a light ray 16 hitting the diffusive side area increases as the light ray moves more toward distal end 17. In this way, if light rays 16 reach the distal end 17, they are more likely to hit a diffusive side area 14 at distal end 17 than they would be if a larger gap G were present between the diffusive side area 14 and the optical element 12 at distal end 17. Although diffusive side areas 14 are illustrated in FIG. 8 as lopped wedges, they could be any suitable shape.

If the diffusive side areas 14 are created by sandblasting, the degree of sandblasting can vary along the length of the optical element 12 to increase the uniformity of the light output across the length of the optical element. Specifically, there can be less sandblasting near the proximate end 15 and increasingly more sandblasting (to create a rougher surface) along the length of the optical element 12 toward distal end 17. In some cases, the increase is linear, although the rate of increase need not be constant.

Adding the diffusive side areas 14 described above can help extend the distance across which light is dispersed uniformly from an optical element 12.

In one non-limiting embodiment, a reflective material (such as but not limited to aluminum tape) is applied to portions of the optical element 12 that do not have diffusive side areas, for example, but not limited to, top side surface 26.

As mentioned, the light scattering properties of the silicone component used with optical element 12 may be such that diffusive side areas are not included at all. For example, the light scattering properties of the silicone component without diffusive side areas may be sufficient where relatively short lighting is needed. For example, an optical element having a silicone component without diffusive side areas may be used in applications such as aircraft exit lighting, lavatory lighting, etc.

As shown in FIG. 2, distal end 17 of optical element 12 may include a reflective element 20. In some embodiments, reflective element 20 is aluminum, but can be any suitable reflective material including white or silver reflective paint. When light rays 16 that did not hit a diffusive side area 14 reach the reflective distal end 20, the light ray is reflected (recycled) back into the optical element 12 and reflects by TIR until it hits a diffusive side area 14 and is emitted from the optical element 12. This reflection (recycling) of the light rays enhances the light output.

In some embodiments, the optical elements are used in aircraft and can be used for ceiling lighting, doorway lighting, entryway lighting, galley lighting, side wall lighting, recessed lighting, exit lighting, lavatory lighting, etc., although the optical elements described herein may be used to illuminate any desired area or surface and are not limited to use in an aircraft.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. An aircraft optical element, the optical element comprising:
an optical grade silicone component;
a distal end and a proximate end adapted to be coupled to a light source; and
a plurality of diffusive side areas arranged on the silicone component, wherein each of the diffusive side areas is configured to re-direct a light ray traversing by total internal reflection along a longitudinal axis of the optical element so that the light ray is emitted out of the optical element generally orthogonal to the longitudinal axis;
wherein a distance between adjacent diffusive side areas decreases along a length of the optical element from the proximate end toward the distal end.

2. The optical element of claim 1, wherein the decrease in the distance between adjacent diffusive side areas increases the uniformity of the light rays being emitted out of the optical element.

3. The optical element of claim 1, wherein the silicone component is positioned within an aperture of a transparent, rigid rod.

4. The optical element of claim 1, wherein the silicone component at least partially surrounds a rigid rod.

5. The optical element of claim 1, wherein the diffusive side areas are arranged as strips.

6. The optical element of claim 1, wherein the diffusive side areas are in a generally spiral arrangement.

7. The optical element of claim 1, wherein the diffusive side areas are texturized areas.

8. An optical element adapted to be coupled to a light source, the optical element comprising:
an optical grade silicone component;
a proximate end and a distal end; and
a plurality of diffusive side areas arranged on the optical grade silicone component, wherein each of the diffusive side areas is positioned on the silicone component and is configured to re-direct a light ray traversing along a longitudinal axis of the optical element such that the light ray is emitted out of the optical element generally orthogonal to the longitudinal axis;
wherein the diffusive side areas are arranged and patterned such that a probability of the light ray hitting one of the plurality of diffusive side areas increases as the light ray moves from the proximate end toward the distal end of the optical element.

9. The optical element of claim 8, wherein a distance between adjacent diffusive side areas decreases along the length of the optical element from the proximate end toward the distal end.

10. The optical element of claim 8, wherein the arrangement of the diffusive side areas increases the uniformity of the light rays being emitted out of the optical element.

11. The optical element of claim 8, wherein the optical component further comprises a transparent, rigid rod and wherein the silicone component either at least partially surrounds the rod or is positioned within an aperture of the rod.

12. The optical element of claim 8, wherein the diffusive side areas are arranged as strips.

13. The optical element of claim 8, wherein the diffusive side areas are in a generally spiral arrangement.

14. The optical element of claim 8, wherein the diffusive side areas are ridges and wherein a height of the ridges increases along a length of the optical element from the proximate end to the distal end.

15. The optical element of claim 8, wherein the diffusive side areas are a reflective material.

16. The optical element of claim 8, wherein the diffusive side areas are texturized.

17. A method of using an optical element in an aircraft, the method comprising:
providing an optical element comprising an optical grade silicone component;
coupling the optical element to a light source; and
directing a light ray into the optical element along a longitudinal axis of the optical element such that the light ray is re-directed and emitted out of the optical element generally orthogonal to the longitudinal axis in a uniform matter along a length of the optical element.

18. The method of claim 17, further comprising at least partially surrounding a rigid rod with the optical grade silicone component.

19. The method of claim 17, further comprising positioning the optical grade silicone component within an aperture of a rigid rod.
